(19) United States
(12) Patent Application Publication
(10) Pub. No.: US 2016/0117081 A1
(43) Pub. Date: Apr. 28, 2016

(54) CONTROLLING ENTERTAINMENT SYSTEM USING COMBINATION OF INPUTS FROM PROXIMITY SENSOR AND TOUCH SENSOR OF REMOTE CONTROLLER

(71) Applicant: Thales Avionics, Inc., Irvine, CA (US)

(72) Inventor: Steven PUJIA, Lake Elsinore, CA (US)

(21) Appl. No.: 14/524,267

(22) Filed: Oct. 27, 2014

(51) Int. Cl. G06F 3/0484; G06F 3/0488; G06F 3/01; G06F 3/0482

(52) U.S. Cl. CPC G06F 3/04842; G06F 3/0482; G06F 3/04883; G06F 3/017; G06F 2203/04806

(57) ABSTRACT

An entertainment system includes a video display unit (VDU) that receives hover location information and a touch selection signal from a remote controller. The hover location information indicates a location of the user movable object while adjacent to but not contacting the remote controller. The touch selection signal indicates when the user movable object is contacting the remote controller. The VDU displays user selectable indicia spaced apart on a display device, and displays an object tracking indicia that is moved proportional to changes identified in the hover location information over time. The VDU identifies one user selectable indicia as being touch selected by the user responsive to receipt of the touch selection signal while the object tracking indicia is positioned within a touch selection region associated with the user selectable indicia, and controls an operation of the VDU based on program code associated with the user selectable indicia.

### TECHNICAL FIELD

Embodiments described herein relate generally to electronic entertainment systems and, more particularly, to man-machine interfaces for controlling entertainment systems.

### BACKGROUND

Automated gesture recognition has been the subject of considerable study since 1995. One objective of gesture recognition was control of machines, as described in U.S. Pat. No. 5,594,469 to Freeman et al entitled HAND GESTURE MACHINE CONTROL SYSTEM. The approach used by Freeman et al. was to have a hand gesture in space cause movement of an on-screen displayed hand icon over an on-screen displayed machine control icon. The hand icon moved the machine control icon to effectuate machine control.

In U.S. Pat. No. 6,002,808 to Freeman entitled HAND GESTURE CONTROL SYSTEM, hand gestures are sensed optically through use of a camera, and converted into a digital representation based on horizontal and vertical position of the hand, length and width of the hand, and orientation of the hand.

In U.S. Pat. No. 7,058,204 to Hildreth et al. entitled MULTIPLE CAMERA CONTROL SYSTEM, a multi-camera technology is described, whereby a person can control a screen by pointing a finger.

Gesture recognition has many advantages over various physical interfaces, such as a touch screen display displays. Touch screen display displays need to be positioned within the convenient reach of a person. When touch screen display displays are intended for use in a public setting, frequency touching by many different people raises hygiene problems. Moreover, touch screen display displays are subject to wear, which can diminish their useful life and increase maintenance costs.

However, gesture recognition has received limited success in commercial products because of difficulties with determination of remote gesture commands by users.

### SUMMARY

Some embodiments of the present disclosure are directed to an electronic system that includes a video display unit for use with a remote controller. The video display unit is separate and spaced apart from the remote controller, and includes a transceiver, a display device, and a processor. The transceiver is configured to communicate through a wireless RF channel with the remote controller to receive hover location information and a touch selection signal. The hover location information indicates a location of the user movable object relative to the remote controller while the user movable object is adjacent to but not contacting the remote controller. The touch selection signal indicates when the user movable object is contacting the remote controller. The processor displays a plurality of user selectable indicia spaced apart on the display device, and displays an object tracking indicia that is moved proportional to changes identified in the hover location information over time. The processor identifies one of the user selectable indicia as being touch selected by the user responsive to receipt of the touch selection signal while the object tracking indicia is positioned within a touch selection region associated with the one of the user selectable indicia, and controls an operation of the video display unit based on execution of program code associated with the one of the user selectable indicia that is touch selected.

Some other embodiments are directed to a method by a video display unit. Hover location information and a touch selection signal are received from a remote controller that is separate and spaced apart from the video display unit. A plurality of user selectable indicia are displayed spaced apart on a display device of the video display unit. A displayed object tracking indicia is moved proportional to changes identified in the hover location information over time. One of the user selectable indicia is identified as being touch selected by the user responsive to receipt of the touch selection signal while the object tracking indicia is positioned within a touch selection region associated with the one of the user selectable indicia. An operation of the video display unit is controlled based on execution of program code associated with the one of the user selectable indicia that is touch selected.

It is noted that aspects described with respect to one embodiment may be incorporated in different embodiments although not specifically described relative thereto. That is, all embodiments and/or features of any embodiments can be combined in any way and/or combination. Moreover, other video display units, remote controllers, methods, and/or computer program products according to embodiments will be or become apparent to one with skill in the art upon review of the following drawings and detailed description. It is intended that all such additional video display units, remote controllers, methods, and/or computer program products be included within this description and protected by the accompanying claims.

### BRIEF DESCRIPTION OF THE DRAWINGS

The accompanying drawings, which are included to provide a further understanding of the disclosure and are incorporated in and constitute a part of this application, illustrate certain non-limiting embodiments of the invention. In the drawings:

FIG. 1 illustrates a remote controller having a proximity sensor and a touch sensor, and a video display unit that moves a displayed object tracking indicia proportional to changes identified in hover location information from the proximity sensor and selects among user selectable indicia responsive to a signal from the touch sensor, according to some embodiments;

FIG. 2-5 are flowcharts of operations and methods that can be performed by a video display unit in accordance with some embodiments;

FIGS. 6-9 illustrate operations that a user can perform using gestures while contacting a remote controller to cause corresponding operations to be performed by a video display unit in accordance with some embodiments;

FIG. 10 is a block diagram of an entertainment system that includes video display units controlled by remote controllers having proximity sensors and touch sensors which are configured according to some embodiments of the present invention disclosure;

FIG. 11 illustrates a block diagram of a remote controller that includes a proximity sensor and a touch sensor configured according to some embodiments; and

FIG. 12 illustrates a block diagram of a video display unit that is configured according to some embodiments.

### DETAILED DESCRIPTION

The following detailed description discloses various non-limiting example embodiments of the invention. The invention can be embodied in many different forms and is not to be construed as limited to the embodiments set forth herein.

Some embodiments of the present invention may arise from the present realization that In-Flight Entertainment (IFE) systems can be difficult to control using touch-screen interfaces that are part of a seatback video display unit. When touch-screen interfaces are placed in seatbacks of premium and business class seating of an aircraft, the touch-screen interfaces can be located too far away from the facing passengers to be conveniently reached. Moreover, touch-screen interfaces in seatbacks of coach class seating can be difficult to reach when the passengers' seats are reclined.

Although some embodiments are described in the context of controlling an entertainment system, these and other embodiments are limited thereto. Instead embodiments of the present invention may be used with other types of electronic systems including, without limitation, information displays in public areas (e.g., shopping mall directories), projected displays in vehicles (e.g., head-up displays), etc.

A seatback video display unit can include a gesture identification camera that is configured to identify gestures made by a passenger's hand(s) in a facing seat, however the relatively great distance between the gesture identification camera and the passengers hands and the variability in distances between the hands and the gesture identification camera can lead to erroneously interpreted gestures and mistaken interpretation of passenger movement as an intended command to the video display unit. The variability in distances can be the result of different passenger arm lengths and/or varying amounts of passenger reclination in a seat.

One or more of the embodiments disclosed herein may overcome one or more of these difficulties and/or provide other improvements in how users interact with entertainment systems. Although various embodiments of the present invention are explained herein in the context an in-flight entertainment (IFE) environment, other embodiments of entertainment systems and related controllers are not limited thereto and may be used in other environments, including other vehicles such as ships, submarines, buses, trains, commercial/military transport aircraft, and automobiles, as well as buildings such as conference centers, sports arenas, hotels, homes, etc. Accordingly, in some embodiments users are referred to, in a non-limiting way, as passengers.

Various embodiments disclosed herein provided an improved user experience with an entertainment system by allowing a user to control a video display unit by moving a finger, or other object, that is hovering over (i.e., without touching) a remote controller while observing corresponding and proportional movement of an object tracking indicia displayed on the video display unit. The user can thereby steer the object tracking indicia to, for example, overlap user selectable indicia displayed on the video display unit 100, and then touch the remote controller to cause the video display unit to select the user selectable indicia and perform an operation corresponding to the selected indicia.

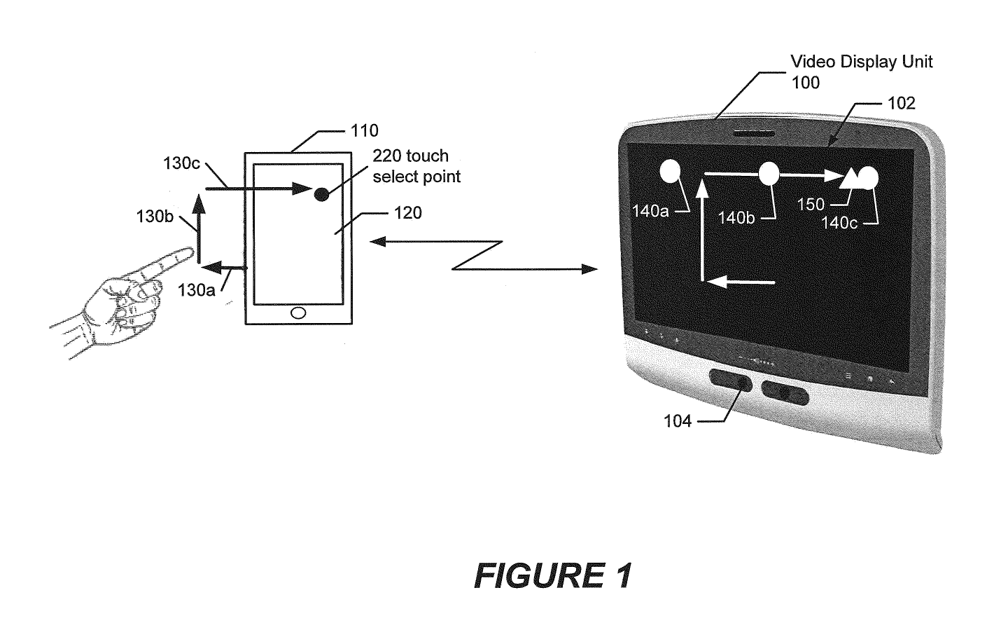

FIG. 1 illustrates an example entertainment system that includes a remote controller 110 and a video display unit 100, according to some embodiments. The remote controller 110 communicates to the video display unit 100 hover location information indicating a Iodation of a user movable object relative to the remote controller 110 while the object is not touching the remote controller 110. The remote controller 110 also communicates a touch selection signal when the user movable object touches a defined location or region on the remote controller 110. The hover location information and the touch selection signal are independently communicated through a wireless RF channel to the video display unit 100. The video display unit 100 moves a displayed object tracking indicia proportional to changes identified in the hover location information and selects among user selectable indicia responsive to the touch selection signal.

The remote controller 110 can be a personal electronic device that is carried by a passenger into communication range of the video display unit 100, including, without limitation, a tablet computer, a laptop computer, a palmtop computer, a cellular smart phone, a media player, etc.

In an embodiment, the remote controller 110 includes a transceiver, a proximity sensor, a touch sensor, and a processor, and may further include a display device 120. The transceiver is configured to communicate through the wireless RF channel with a transceiver of the video display unit 100. The proximity sensor outputs hover location information indicating a location of the user movable object relative to the proximity sensor while the user movable object is adjacent to but not contacting the proximity sensor (i.e., not touching the remote controller 110). Although the proximity sensor is described in some embodiments are sensing movement along a plane (e.g., x and y orthogonal directions), the sensor may furthermore sense movement in three dimensions (e.g., x, y, and z orthogonal directions). The touch sensor outputs a touch selection signal responsive to a user movable object contacting the touch sensor. The processor communicates the hover location information and the touch selection signal through the wireless RF channel.

The video display unit 100 is separate and spaced apart from the remote controller 110. The video display unit 100 can include a transceiver, the display device, and a processor. The transceiver is configured to communicate through a wireless RF channel with the remote controller 110 to receive the hover location information and the touch selection signal.

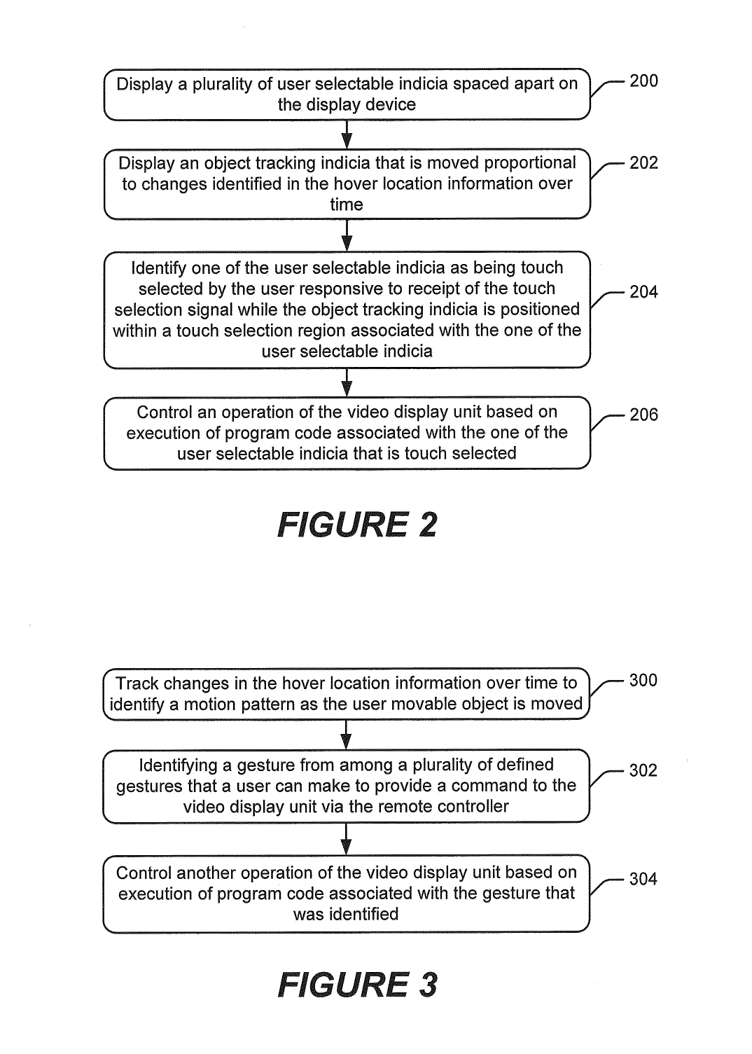

FIG. 2 illustrates methods and operations that may be performed by the processor of the video display unit 100. Referring to FIGS. 1 and 2, the processor displays (block 200) a plurality of user selectable indicia 140a, 140b, 140c (examples of which are illustrated as three circles) spaced apart on the display device 102. The processor displays (block 200) an object tracking indicia 150 (illustrated as a triangle) on the display device 102 that is moved proportional to changes identified in the hover location information over time. The processor identifies (block 204) one of the user selectable indicia 140c as being touch selected by the user responsive to receipt of the touch selection signal while the object tracking indicia 150 is positioned within a touch selection region associated with the user selectable indicia 140c (e.g., illustrated as the rightmost circle that is overlapped by the triangle on the display device 102). The processor responsively controls (block 206) an operation of the video display unit 100 based on execution of program code associated with the one of the user selectable indicia that is touch selected.

As shown in FIG. 1, the user can use a finger or other user movable object to create a gesture that is tracked by the proximity sensor of the remote controller 110. In FIG. 1, a user's finger has been moved along a pathway including three segments: a leftward segment 130a; an upward segment 130b; and a rightward segment 130c. The processor of the video display unit 100 displays an object tracking indicia 150 (illustrated as a triangle) that is moved proportional to location changes identified in the hover location information over time. The object tracking indicia 150 (e.g., the triangle) is moved along a pathway that also includes three segments: a leftward segment; an upward segment; and a rightward segment. Accordingly, the processor the video display unit 100 may determine a direction on the display device 102 for moving object tracking indicia 150 based on determining from the hover location information a direction of movement of the user movable object relative to the proximity sensor the remote controller 110.

The user can thereby move the finger relative to the remote terminal 110 and observe how the object tracking indicia is correspondingly and proportionally moved on the video display unit 100. The user can thereby steer the object tracking indicia 150 to be within a touch selection region of the rightmost user selectable indicia 140c (e.g., the rightmost circle on the display 102). The user can then touch select the touch sensor, such as by touch selecting at the touch selection point 220 on the remote terminal 110 to cause the video display unit 100 to responsively control an operation of the video display unit 100 based on execution of program code associated with the user selectable indicia 140c.

In a further embodiment, the user can move the hovering finger relative to the proximity sensor of the remote controller 110 to form a gesture that is identified by the video display unit 100 as a command to perform an operation is associated with the identified gesture. Referring to the embodiment of FIG. 3, the processor of the video display unit 100 tracks (block 300) changes in the hover location information over time to identify a motion pattern as the finger is moved relative to the proximity sensor of the remote controller 110. A gesture is identified (block 302) from among a plurality of defined gestures that a user can make to provide a command to the video display unit via the remote controller. The processor of the video display unit 100 controls (block 304) an operation of the video display unit 100 based on execution of program code associated with the gesture that was identified.

The processor of the video display unit 100 may be configured to respond to identification of the gesture to control operation of the video display unit 100 by selecting one of a plurality of menu item indicia that are displayed on the display device 102 to cause indicia for sub-menu items to be displayed on the display device. The processor may respond to the identified gesture by selecting one of a plurality of sub-menu indicia that are displayed on the display device 102 to initiate playing of an associated movie, television show, or application on the display device. The processor may respond to the identified gesture by selecting one of a plurality of application indicia that are displayed on the display device 102 to initiate execution of an associated application by the processor. The processor may respond to the identified gesture by controlling audio volume through an audio interface 1244 of the entertainment system. The processor may respond to the identified gesture by controlling playing, pausing, fast forwarding, and/or rewinding of a movie on the display device 102. Alternatively or additionally, the processor may respond to the identified gesture by controlling operation of a game being executed by the processor. The processor may be configured to identify a plurality of different gestures, where each of the gestures is associated with different operational program code that can perform different control operations of the video display unit 100.

Although some embodiments are described in the context of a user moving a single finger or other single object relative to the proximity sensor of the remote controller 110, other embodiments are not limited thereto. For example, the proximity sensor may output hover location information that indicates the location of a plurality of fingers or other objects hovering over the proximity sensor without touching. The processor of the video display unit 100 can control movement of a plurality of object tracking indicia displayed on the display device 102 responsive to tracking movement of the plurality of user movable objects indicated by the hover location information, and can recognize a gesture from among a plurality of defined gestures based on the tracked movement of the plurality of user movable objects.

In a further embodiment, the user can move a finger which is hovering over the proximity sensor of the remote controller 110 while observing corresponding and proportional movements of the object tracking indicia 150 to steer the object tracking indicia 152 location on the display device 102 that is to be used as an anchor point. The user can then move the finger hovering over the proximity sensor to form a gesture that is interpreted by the processor of the video display unit 100 as being performed relative to the anchor point.

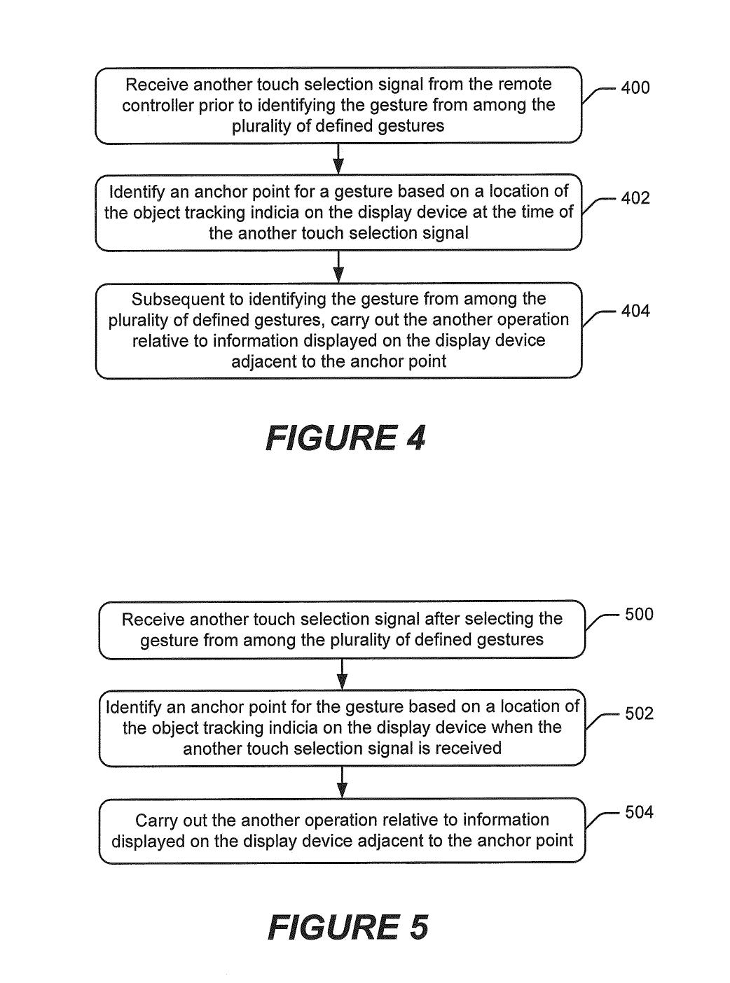

Referring to the embodiment of FIG. 4, the processor of the video display unit 100 receives (block 400) a touch selection signal from the remote controller 110 prior to identifying (block 302 of FIG. 3) the gesture from among the plurality of defined gestures. The processor identifies (block 402) an anchor point for a gesture based on a location of the object tracking indicia on the display device 102 at the time of the touch selection signal. Subsequent to identifying (block 302 of FIG. 3) the gesture from among the plurality of defined gestures, the processor carries out the operation, which is associated with the gesture, relative to information displayed on the display device 102 adjacent to the anchor point. For example, the processor may adjust a magnification zoom level of information displayed on the display device 102 adjacent to the anchor point responsive to operations defined by the identified gesture.

In a further embodiment, the user can move a finger which is hovering over the proximity sensor of the remote controller 110 to form a gesture that is to be interpreted by the video display unit 100 as a command to perform a corresponding operation. Subsequent to forming the gesture, the user can touch select the remote controller 110 to define an anchor point relative to which the operation is to be performed. Referring to the embodiment of FIG. 5, the processor of the video display unit 100 receives (block 500) a touch selection signal after identifying (block 302 of FIG. 3) the gesture from among the plurality of defined gestures. The processor identifies (block 502) an anchor point for the gesture based on a location of the object tracking indicia on the display device 102 when the touch selection signal is received, and carries out the operation, associate with the gesture, relative to information displayed on the display device 102 adjacent to the anchor point.

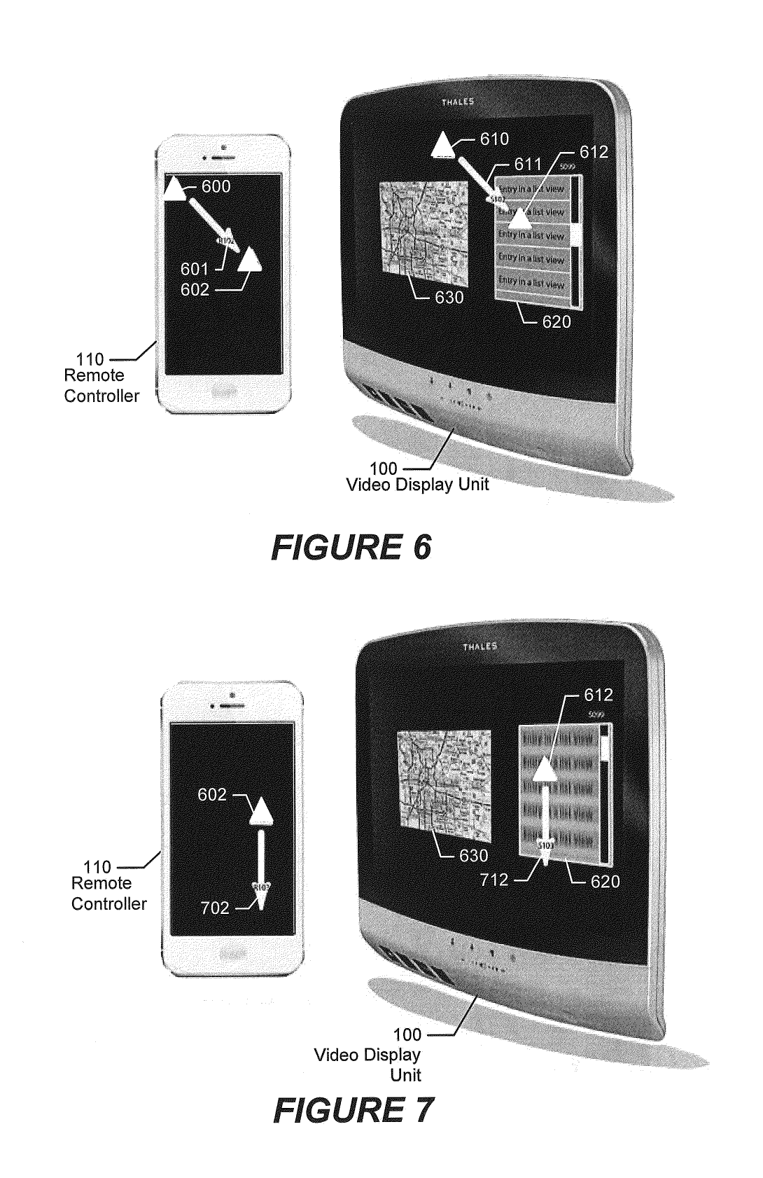

FIGS. 6-9 illustrate operations that a user can perform using gestures while contacting a remote controller to cause corresponding operations to be performed by a video display unit in accordance with some embodiments.

FIGS. 6 and 7 illustrate how a user may perform a swipe down gesture for sensing by the remote controller 110 in order to control the video display unit 100 to scroll a list of displayed items.

Referring to FIG. 6, the video display unit 100 displays a list 620 of user selectable items and a map 630. The user desires to scroll through the list 620 of user selectable items to touch select one of the items to control the video display unit 100 (e.g., touch select a menu command item within a menu list). While viewing the video display unit 100, the user hovers a finger over a proximity sensor of the display of the remote controller 110 and moves the finger from location 600 to location 602 along path 601 without the finger touching the remote controller 110. The video display unit 100 tracks movement of the finger between locations 600 and 602 responsive to changes in the hover location information from the remote controller 110, and makes corresponding movements in the displayed object tracking indicia from location 610 to location 612 along path 611.

Referring to related FIG. 7, when the user determines that the object tracking indicia 612 displayed on the video display unit 100 is positioned within the list 620 to enable scrolling, the user then moves the finger toward the remote controller 110 to contact a touch interface (e.g., touchscreen) at location 602 and slides the finger downward along path 702 while maintaining contact with the touch interface to command the video display unit 100 to scroll the list 620 of items. The video display unit 100 tracks movement of the finger through changes in the touch selection signal and correspondingly scrolls the displayed list 620 of items downward to enable the user to view additional items within the list.

The user may select one of the display items within the list 620 located underneath the indicia 612 to cause a processor of the video display unit 100 to perform operations associated with the selected item. The user may select an item by, for example, maintaining stationary finger contact with the touch interface of the remote controller 110 while the object tracking indicia 710 is at least partially located on the desired item for selection. Alternatively, the user may select an item by lifting the finger to cease contact with the touch interface of the remote controller 110 and then again touching the touch interface to cause selection of the desired item at least partially covered by the object tracking indicia 710.

Accordingly, the remotely displayed object tracking indicia provides feedback to the user to enable hand-eye coordination between movement of the finger relative to the remote controller 110 and corresponding movement of the indicia viewed by the user on the video display unit 100. The user can thereby more naturally interact with the remote controller 110 to allow corresponding interaction with indicia displayed on the video display unit 100. The remote controller 110 thereby acts as a virtual extension of the user's hand when the video display unit 100 is not within comfortable reach of the user and/or when the video display unit 100 is not operationally capable of directly sensing proximity of the user's finger and/or touch selections by the user's finger.

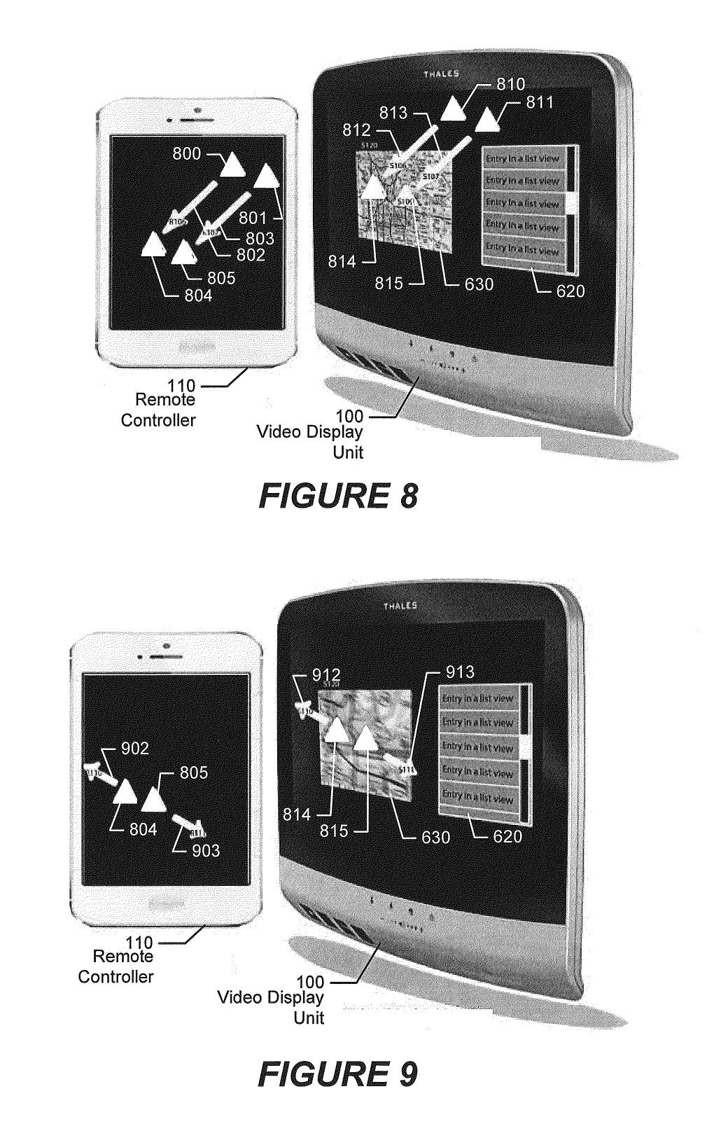

FIGS. 8 and 9 illustrate how a user may perform a finger spread gesture for sensing by the remote controller 110 in order to control the video display unit 100 to change the zoom magnification of a portion of a map 630 displayed on the video display unit 100.

Referring to FIG. 8, while viewing the video display unit 100, the user hovers two fingers over the proximity sensor of the display of the remote controller 110 and moves the fingers from spaced apart locations 800 and 801 to corresponding locations 804 and 805 along corresponding paths 802 and 803 without the fingers touching the remote controller 110. The video display unit 100 tracks movement of the fingers from locations 800 and 801 to corresponding locations 804 and 805 responsive to changes in the hover location information from the remote controller 110, and makes corresponding movements in the displayed object tracking indicias from locations 810 and 811 to corresponding location 814 and 815 along corresponding paths 812 and 813.

Referring to related FIG. 9, when the user determines that the object tracking indicias at locations location 814 and 815 are positioned at desired locations on the map 630, the user then moves the fingers toward the remote controller 110 to contact the touch interface (e.g., touchscreen) at locations 804 and 805 and spreads the fingers apart along paths 902 and 903 while maintaining contact with the touch interface to command the video display unit 100 to perform a zoom operation on the displayed map 630 based on corresponding spreading of the indicias 814 and 815 along paths 912 and 913. The video display unit 100 tracks movement of the fingers through changes in the touch selection signal and correspondingly changes the magnification zoom of the displayed map 630 (e.g., dynamically increases magnification of a portion of the map displayed adjacent to the indicias 814 and 815 responsive to continuing spreading of the user's fingers.

Accordingly, the user can thereby move a plurality of indicia displayed on the video display unit by moving a plurality of corresponding fingers hovering adjacent to the remote controller 110. When the displayed indicia are position where the user desires, the user can then contact the remote controller 110 with the fingers and perform a sliding gesture using the fingers to have the gesture interpreted and performed by the video display unit 100 to control what is displayed by the video display unit 100. The user can thereby again more naturally interact with the remote controller 110 using a multi-finger gesture to allow corresponding interaction with the video display unit 100. The remote controller 110 thereby again acts as a virtual extension of the user's hand when the video display unit 100 is not within comfortable reach of the user and/or when the video display unit 100 is not operationally capable of directly sensing proximity of the user's fingers and/or multi-touch selections by the user's fingers.

Although a scrolling gesture and pinch gesture have been described, other gestures may be formed by the user moving multiple fingers or other objects. Other gestures that can be used by the user to command the video display unit can include, without limitation, multiple simultaneous taps, swipe-up/swipe-sideways/swipe-down multiple simultaneous objects, rotating multiple simultaneous objects, pinch together/apart multiple simultaneous objects, etc.

Example Entertainment System with Remote Controllers and Video Display Units:

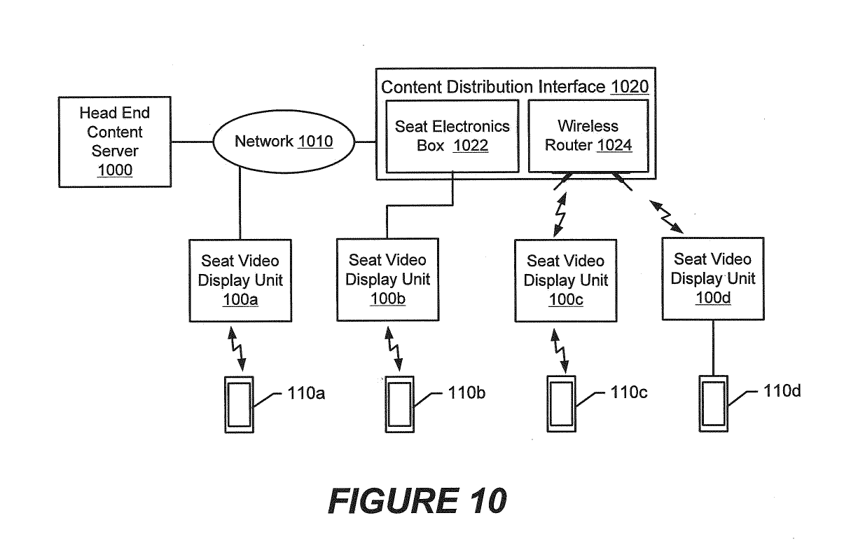

FIG. 10 is a block diagram of an entertainment system that includes remote controllers 110a-d, seat video display units (SVDUs) 100a-d, and other system components which are configured according to some embodiments of the present invention. Referring to FIG. 10, the system includes a head end content server 1000 that contains content that can be downloaded to the SVDUs 100a-d through a data network 1010 and a content distribution interface 1020. The content distribution interface 1020 can include seat electronics boxes 1022, each of which can be spaced apart adjacent to different groups of seats, and/or a wireless router 1024.

Example content that can be downloaded from the head end content server 1000 can include, but is not limited to, movies, TV shows, other video, audio programming, and application programs (e.g. game programs). The wireless router 1024 may be a WLAN router (e.g. IEEE 802.11, WIMAX, etc), a cellular-based network (e.g. a pico cell radio base station), etc.

The SVDUs 100a-d are connected to request and receive content from the head end content server 1000 through a wired and/or wireless network connections through the content distribution interface 1020.

When used in an aircraft environment, the SVDUs 100a-d can be attached to seatbacks so that they face passengers in a following row of seats. The remote controllers 110a-d would each typically be connected to a corresponding one of the SVDUs 100a-d through a wireless RF channel (e.g., WLAN peer-to-peer, Bluetooth, etc.) or may be tethered by a cable (e.g. wire/communication cable) to an associated one of the SVDUs. For example, remote controllers 110a-c are connected through wireless RF channels to respective SVDUs 100a-c. The remote controller 100d is connected through a wired communication cable (e.g. serial communication cable) to the SVDU 100d.

In accordance with some embodiments, a passenger can operate a remote controller 110 to control what content is displayed and/or how the content is displayed on the associated SVDU 100 and/or on the remote controller 110. For example, a passenger can operate the remote controller 110b to select among movies, games, audio program, and/or television shows that are listed on the SVDU 100b, and can cause a selected movie/game/audio program/television show to be played on the SVDU 100b, played on the remote controller 110b, or played on a combination of the SVDU 100b and the remote controller 110b (e.g., concurrent display on separate screens).

Each of the remote controllers 110a-d in the IFE system may be assigned a unique network address (e.g., media access control (MAC) address, Ethernet address). In addition, the SVDUs 100a-d may be each assigned a unique network address (e.g., MAC address, Ethernet address) which are different from the network addresses of the respective communicatively coupled remote controllers 110a-d. In some embodiments, a remote controller 110b and a SVDU 100b may be coupled with a same seat-end electronics box 1022 (when utilized by the system) that functions as a local network switch or node to provide network services to SVDUs at a group of passenger seats, for example a row of seats. In other embodiments, the remote controller 110b and the respective SVDU 100b may be coupled with different seat-end electronics boxes 1022 (when utilized by the system). For example, a remote controller 110 for use by a passenger in an aircraft seat identified by a passenger readable identifier (e.g., a printed placard) as seat “14B” may be attached to a seat electronics box 1022a that provides network connections to row “14”, while the SVDU 100b installed in the seat back in front of seat “14B” for use by the passenger in seat “14B” may be attached to a different seat electronics box 1022b that provides network connections to row “13.”

### Example Remote Controller:

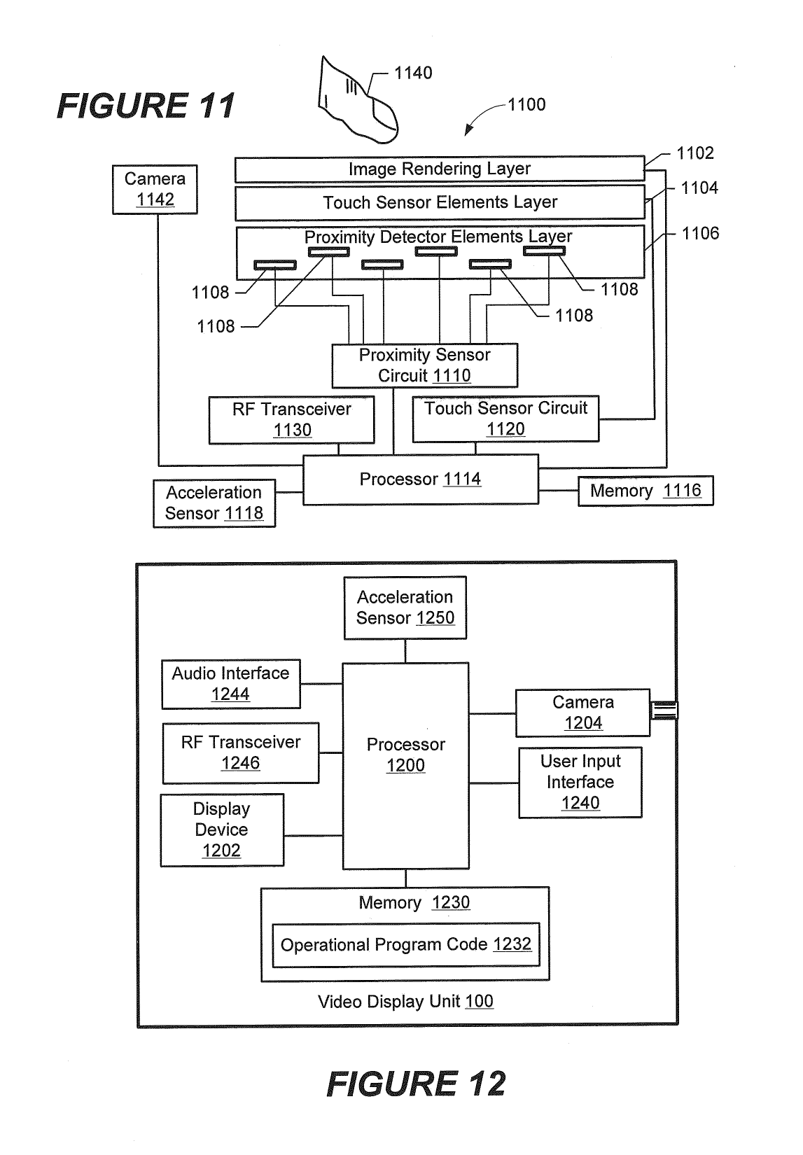

FIG. 11 illustrates a block diagram of a remote controller 1100 that includes a proximity sensor circuit 1110, a touch sensor circuit 1120, a RF transceiver 1130, and a processor 1114 configured according to some embodiments.

The proximity sensor circuit 1120 includes a plurality of proximity detector elements (e.g., plates) 1108 arranged in a layer 1106 (e.g., on a substrate). The proximity sensor circuit 1120 electrically charges the proximity detector elements 1108 to generate capacitive coupling to a user's finger 1140 or other user movable object, and operates to determine therefrom the hover location information indicating a location (e.g., coordinates) of the user's finger or other user movable object relative to the proximity detector elements 1108 while the user movable object is hovering over the proximity detector elements 1108 (i.e., adjacent to but not contacting the remote controller 1100).

The touch sensor circuit 1120 can include a touch sensitive display device formed by an image rendering layer 1102 configured to display text and/or graphical objects responsive to signals from the processor 1114, and a layer of touch sensor elements 1104 that generate a touch selection signal which indicates a location (e.g., coordinates) where a user touch selected the image rendering layer 1102.

The RF transceiver 1130 is configured to communicate the touch selection signal and the hover location information through a wireless RF channel to a transceiver of the video display unit 100.

Remote controller may alternatively not include a touch sensitive display. For example, the remote controller may include a proximity sensor mounted on an armrest of the seat occupied by user, or mounted in a tray table that folds down from a seat back facing a user. The touch sensor may more simply indicate when a user has touch selected the remote controller (e.g., has touch selected to switch adjacent to the proximity sensor and/or has touch selected the proximity sensor itself).

The processor 1114 includes one or more data processing circuits, such as a general purpose and/or special purpose processor (e.g., microprocessor and/or digital signal processor). The processor 1114 is configured to execute computer program instructions from operational program code in a memory 1116, described below as a computer readable medium, to perform some or all of the operations and methods that are described herein for one or more of the embodiments.

In yet another embodiment, the proximity sensor includes a camera 1142 and associated circuitry that tracks movement of user's finger or other movable object hovering adjacent to the remote controller 110. The camera 1142 outputs a video stream as the hover location information. The processor 1114 can be configured to process the video stream data to identify the hover location information for the location of the user movable object relative to the remote controller 110 while the user movable object is within a field of view of the camera 1142 and the touch selection signal is not presently indicating that the user movable object is touching the touch sensor.

In an aircraft or other moving vehicle environment, the passenger may experience vibration or other turbulence that can cause an extended hand to move relatively uncontrollably. While an aircraft is experiencing turbulence, for example, it may not be possible for a passenger to point in a steady manner relative to the remote controller 110, and it may be similarly difficult for the passenger to accurately form a motion (e.g., horizontal sweeping motion) relative to the remote controller 110 to provide a control gesture to control the video display unit 100 in a desired manner. It is therefore possible for turbulence to cause shaking or other undesired movement of a person's hand, arm, etc., that is fed through the proximity sensor 1110 and the processor 1114 within the hover location information. The vibration induced effects on the hover location information can lead to misinterpretation of a gesture that the passenger is attempting to create and, thereby, trigger undesired operational change by the video display unit 100. Similarly, the vibration induced effects on the hover location information may cause a gesture to be identified when the user is not intending such action.

In accordance with some embodiments, the remote controller 1100 includes an acceleration sensor 1118 that senses acceleration of the remote controller 1100 to output an acceleration signal. The acceleration sensor 1118 may include a single accelerometer or a plurality of accelerometers that are arranged to measure translational and/or rotational acceleration relative to a plurality of orthogonal axes.

The processor 1114 can be configured to compensate the shape of motions that are forming a gesture as sensed by the proximity sensor 1110 to reduce or eliminate effects of the sensed acceleration on the sensed gesture. For example, the processor 1114 can use the acceleration signal to at least partially compensate for effect of acceleration turbulence on the user movable object controlled by the passenger when interpreting movement of the user movable object over time in the hover location information. The processor 1114 may generate a velocity compensation vector responsive to integration of the acceleration signal over a defined time period, and subtract the velocity compensation vector from a contemporaneous motion of the user movable object when generating the hover location information.

The processor 1114 can also be configured to augment the shape of motions that are forming a gesture based on software algorithms such as noise filters and dampening that take into account the variations of motion and its magnitude, as well as assumptions and comparisons based on what a realistic user motions would be like. In addition, historical data of the user's previous motions and interactions with the system may also be considered. Furthermore, the logic can be adaptive to deal with changing circumstances over time, for example if large oscillations in data for shape of motion are measured, dampening is increased, and conversely dampening is reduced as oscillations decrease. Dampening of oscillations in the data may be increased responsive to increased vibration indicated in the acceleration signal and decreased responsive to decreased vibration indicated in the acceleration signal. Over time, the system may “learn” how to effectively interpret input from the user and the environment and employ solutions that would maximize the user experience.

### Example Video Display Unit:

FIG. 12 illustrates a block diagram of a video display unit 100 that is configured according to some embodiments. The video display unit 100 includes a RF transceiver 1246, a display device 1202, and a processor 1200 that executes computer program code from a memory 1230. The RF transceiver 1246 is configured to communicate through a wireless RF channel with the remote controller 110 to receive hover location information and a touch selection signal. The video display unit 100 may further include a user input interface (e.g., touch screen, keyboard, keypad, etc.) and an audio interface 1244 (e.g., audio jack and audio driver circuitry).

The processor 1200 includes one or more data processing circuits, such as a general purpose and/or special purpose processor (e.g., microprocessor and/or digital signal processor). The processor 1200 is configured to execute computer program instructions from operational program code 1232 in a memory 1230, described below as a computer readable medium, to perform some or all of the operations and methods that are described herein for one or more of the embodiments.

In some embodiments, the video display unit includes a gesture control camera 1204 that is used in combination the hover location information from the remote controller 110 to identify a gesture command formed by a user. The gesture control camera 1204 and associated circuitry can be configured to generate a camera signal responsive to light reflected from the user movable object it is while hovering adjacent to the proximity sensor of the remote controller 110. The processor 1200 analyzes the camera signal to identify a gesture made by a passenger moving the user movable object, and uses both the hover location information and the gesture identified from the camera signal over time to control movement of the object tracking indicia displayed on the display device.

As explained above, in an aircraft or other moving vehicle environment the passenger may experience vibration or other turbulence that can cause an extended hand to move relatively uncontrollably. It is therefore possible for turbulence to cause shaking or other undesired movement of a person's hand, arm, etc., that can cause the processor 1200 to misinterpret based on changes in the cover location information over time a gesture that the passenger is attempting to create and, thereby, trigger undesired operational change by the video display unit 100.

In accordance with some embodiments, the video display unit 100 includes an acceleration sensor 1250 that senses acceleration of the video display unit 100 to output an acceleration signal. The acceleration sensor 1250 may include a single accelerometer or a plurality of accelerometers that are arranged to measure translational and/or rotational acceleration relative to a plurality of orthogonal axes.

The processor 1200 can be configured to compensate the shape of motions that are forming a gesture as determined from the hover location information from the remote controller 110 to reduce or eliminate effects of the sensed acceleration on the sensed gesture. For example, the processor 1200 can use the acceleration signal to at least partially compensate for effect of acceleration turbulence on the user movable object controlled by the passenger when interpreting movement of the user movable object over time in the hover location information. The processor 1200 may generate a velocity compensation vector responsive to integration of the acceleration signal over a defined time period, and subtract the velocity compensation vector from a contemporaneous motion of the user movable object determine from the hover location information. The processor 1200 can then identify a gesture from among a plurality of defined gestures based on the vibration compensated motion of the user movable object.

In another embodiments, the processor 1200 enlarges the minimum size at which any of the user selectable indicia are displayed in response to detecting a threshold amount of vibration of the video display unit 100. Accordingly, when an aircraft is subject to turbulence, the indicia can be enlarged to facilitate the user's selection and reduce the likelihood of erroneous detected selections as the user's hand is shaken by the turbulence.

### Further Definitions and Embodiments

In the above-description of various embodiments of the present invention, it is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another node, it can be directly connected, coupled, or responsive to the other element or intervening element may be present. In contrast, when an element is referred to as being “directly connected”, “directly coupled”, “directly responsive”, or variants thereof to another element, there are no intervening element present. Like numbers refer to like element throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks.

A tangible, non-transitory computer-readable medium may include an electronic, magnetic, optical, electromagnetic, or semiconductor data storage system, apparatus, or device. More specific examples of the computer-readable medium would include the following: a portable computer diskette, a random access memory (RAM) circuit, a read-only memory (ROM) circuit, an erasable programmable read-only memory (EPROM or Flash memory) circuit, a portable compact disc read-only memory (CD-ROM), and a portable digital video disc read-only memory (DVD/BlueRay).

The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks. Accordingly, embodiments of the present invention may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated. Moreover, although some of the diagrams include arrows on communication paths to show a primary direction of communication, it is to be understood that communication may occur in the opposite direction to the depicted arrows.

Many different embodiments have been disclosed herein, in connection with the above description and the drawings. It will be understood that it would be unduly repetitious and obfuscating to literally describe and illustrate every combination and subcombination of these embodiments. Accordingly, the present specification, including the drawings, shall be construed to constitute a complete written description of various example combinations and subcombinations of embodiments and of the manner and process of making and using them, and shall support claims to any such combination or subcombination.

Many variations and modifications can be made to the embodiments without substantially departing from the principles of the present invention. All such variations and modifications are intended to be included herein within the scope of the present invention.

What is claimed:

1. An electronic system for use with a remote controller, comprising:
a video display unit that is separate and spaced apart from the remote controller, the video display unit comprising:
a transceiver configured to communicate through a wireless RF channel with the remote controller to receive hover location information and a touch selection signal, the hover location information indicating a location of the user movable object relative to the remote controller while the user movable object is adjacent to but not contacting the remote controller, and the touch selection signal indicating when the user movable object is contacting the remote controller;
a display device; and
a processor that displays a plurality of user selectable indicia spaced apart on the display device, displays an object tracking indicia that is moved proportional to changes identified in the hover location information over time, identifies one of the user selectable indicia as being touch selected by the user responsive to receipt of the touch selection signal while the object tracking indicia is positioned within a touch selection region associated with the one of the user selectable indicia, and controls an operation of the video display unit based on execution of program code associated with the one of the user selectable indicia that is touch selected.

2. The electronic system of claim 1, wherein:
the processor of the video display unit continues to move where the object tracking indicia is displayed on the display device responsive to changes in the touch selection signal indicating changes in location where the user movable object is contacting the remote controller.

3. The electronic system of claim 2, wherein:
the processor of the video display unit tracks changes in the touch selection signal indicating changes in location where the user movable object is contacting the remote controller over time to identify a motion pattern as the user movable object is moved while contacting the remote controller, identifies a gesture from among a plurality of defined gestures that a user can make to provide a command to the video display unit via the remote controller, and controls another operation of the video display unit based on execution of program code associated with the gesture that was recognized.

4. The electronic system of claim 3, wherein:
the processor controls movement of a plurality of object tracking indicia displayed on the display device responsive to tracking movement of a plurality of user movable objects contacting the remote controller as indicated by the touch selection signal, and identifies the gesture based on the tracked movement of the plurality of user movable objects.

5. The electronic system of claim 1, wherein:
the processor of the video display unit tracks changes in the hover location information over time to identify a motion pattern as the user movable object is moved, identifying a gesture from among a plurality of defined gestures that a user can make to provide a command to the video display unit via the remote controller, and controls another operation of the video display unit based on execution of program code associated with the gesture that was recognized.

6. The electronic system of claim 5, wherein:
the processor controls movement of a plurality of object tracking indicia displayed on the display device responsive to tracking movement of a plurality of user movable objects indicated by the hover location information, and identifies the gesture based on the tracked movement of the plurality of user movable objects.

7. The electronic system of claim 5, wherein:
the processor determines a direction on the display device for moving the object tracking indicia based on determining a direction of movement of the user movable object relative to a proximity sensor of the remote controller.

8. The electronic system of claim 5, wherein the processor is configured to respond to identification of the gesture by performing one of the following commands to control operation of the video display unit:
select one of a plurality of menu item indicia that are displayed on the display device to cause indicia for sub-menu items to be displayed on the display device;
select one of a plurality of movie indicia that are displayed on the display device to initiate playing of an associated movie on the display device;
select one of a plurality of application indicia that are displayed on the display device to initiate execution of an associated application by the processor;
control audio volume through an audio interface of the electronic system;
control playing, pausing, fast forwarding, and/or rewinding of a movie on the display device; and/or
control operation of a game being executed by the processor.

9. The electronic system of claim 5, wherein:
the processor of the video display unit receives another touch selection signal from the remote controller prior to identifying the gesture from among the plurality of defined gestures, identifies an anchor point for a gesture based on a location of the object tracking indicia on the display device at the time of the another touch selection signal, and subsequent to identifying the gesture from among the plurality of defined gestures carries out the another operation relative to information displayed on the display device adjacent to the anchor point.

10. The electronic system of claim 9, wherein:
the processor of the video display unit adjusts a magnification zoom level of the information displayed on the display device adjacent to the anchor point responsive to the gesture.

11. The electronic system of claim 5, wherein:
the processor of the video display unit receives another touch selection signal after identifying the gesture from among the plurality of defined gestures, identifies an anchor point for the gesture based on a location of the object tracking indicia on the display device when the another touch selection signal is received, and carries out the another operation relative to information displayed on the display device adjacent to the anchor point.

12. The electronic system of claim 1, further comprising:
the remote controller comprising:
a transceiver configured to communicate through the wireless RF channel with the transceiver of the video display unit;
a touch sensor that outputs a touch selection signal responsive to a user movable object contacting the touch sensor;
a proximity sensor that outputs hover location information indicating a location of the user movable object relative to the proximity sensor while the user movable object is adjacent to but not contacting the proximity sensor; and
a processor that communicates the hover location information and the touch selection signal through the wireless RF channel.

13. The electronic system of claim 12, wherein:
the proximity sensor comprises a plurality of sensor plates that are electrically charged to generate capacitive coupling to the user movable object and to determine therefrom the hover location information indicating a location of the user movable object relative to the proximity sensor while the user movable object is adjacent to but not contacting the proximity sensor.

14. The electronic system of claim 13, wherein:
the proximity sensor is mounted in an armrest or a tray table of a seat occupied by the user.

15. The electronic system of claim 13, wherein:
the touch sensor comprises a touch sensitive display device that outputs the touch selection signal indicating a contact location of the user movable object when it contacts the touch sensitive display device.

16. The electronic system of claim 12, wherein the video display unit further comprises:
a gesture control camera configured to generate a camera signal responsive to light reflected from the user movable object while hovering adjacent to the proximity sensor; and
the processor analyzes the camera signal to identify a gesture made by a passenger moving the user movable object, and uses both the hover location information and the gesture identified from the camera signal over time to control movement of the object tracking indicia displayed on the display device.

17. The electronic system of claim 12, wherein:
the proximity sensor comprises a camera that outputs video stream data as the hover location information; and
the processor is configured to process the video stream data to identify the hover location information for the location of the user movable object relative to the remote controller while the user movable object is within a field of view of the camera and the touch selection signal is not presently indicating that the user movable object is touching the touch sensor.

18. The electronic system of claim 1, further comprising:
an acceleration sensor that outputs an acceleration signal that indicates a level of acceleration turbulence experienced by the electronic system while carried by a vehicle, wherein
the processor uses the acceleration signal to at least partially compensate for effect of acceleration turbulence on the user movable object controlled by the passenger when interpreting movement of the user movable object over time in the hover location information.

19. The electronic system of claim 18, wherein:
the processor generates a velocity compensation vector responsive to integration of the acceleration signal over a defined time period, and subtracts the velocity compensation vector from a contemporaneous motion of the user movable object identified in the hover location information.

20. A method by a video display unit comprising:
receiving hover location information and a touch selection signal from a remote controller that is separate and spaced apart from the video display unit, the hover location information indicating a location of a user movable object relative to the remote controller while the user movable object is adjacent to but not contacting the remote controller, and the touch selection signal indicating when the user movable object is contacting the remote controller;
displaying a plurality of user selectable indicia spaced apart on a display device of the video display unit;
displaying an object tracking indicia that is moved proportional to changes identified in the hover location information over time;
identifying one of the user selectable indicia as being touch selected by the user responsive to receipt of the touch selection signal while the object tracking indicia is positioned within a touch selection region associated with the one of the user selectable indicia; and
controlling an operation of the video display unit based on execution of program code associated with the one of the user selectable indicia that is touch selected.
